(19) United States
(12) Patent Application Publication
(10) Pub. No.: US 2003/0063750 A1
(43) Pub. Date: Apr. 3, 2003

(54) Unique on-line provisioning of user terminals allowing user authentication

(76) Inventors: Alexander Medvinsky, San Diego, CA (US); Petr Peterka, San Diego, CA (US); Paul Moroney, Olivehain, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/966,552

(22) Filed: Sep. 26, 2001

(51) Int. Cl. H04L 9/00

(52) U.S. Cl. 380/277

(57) ABSTRACT

A provisioning system that secures delivery of a client's public key to a KDC (Key Distribution Center). The provisioning system comprises a client, uniquely identifiable by one or more parameters including a user ID (identification); a provisioning server for registering the client; a key distribution center for generating a provisioning key associated with the user ID, the provisioning key being forwarded to the provisioning server; the provisioning server generating configuration parameters for initializing the client, the provisioning key being included in the configuration parameters; and upon initialization, the client provides its public key, authenticated with the provisioning key for forwarding to the key distribution center.

### CROSS-REFERENCES TO RELATED APPLICATIONS

This application is related to the following U.S. non-provisional applications, U.S. patent application Ser. No. ______, entitled “KEY MANAGEMENT INTERFACE TO MULTIPLE AND SIMULTANEOUS PROTOCOLS” filed ______, 2001; U.S. patent application Ser. No. ______, entitled “KEY MANAGEMENT PROTOCOL AND AUTHENTICATION SYSTEM FOR SECURE INTERNET PROTOCOL RIGHTS MANAGEMENT ARCHITECTURE” filed ______, 2001; U.S. patent application Ser. No. ______, entitled “ENCRYPTION OF STREAMING CONTROL PROTOCOLS SUCH AS RTCP AND RTSP AND THEIR HEADERS TO PRESERVE ADDRESS POINTERS TO CONTENT AND PREVENT DENIAL OF SERVICE” filed ______, 2001; U.S. patent application Ser. No. ______, entitled “ACCESS CONTROL AND KEY MANAGEMENT SYSTEM FOR STREAMING MEDIA” filed ______, 2001; and U.S. patent application Ser. No. ______, entitled “ASSOCIATION OF SECURITY PARAMETERS FOR A COLLECTION OF RELATED STREAMING PROTOCOLS: RTP, RTSP, RTCP” filed ______, 2001, all of which are hereby incorporated by reference in their entirety as set forth in full in the present invention, for all purposes.

### BACKGROUND OF THE INVENTION

The present invention relates generally to the field of data communication and more specifically to rights management and securing data communicated in a network.

Conventional digital rights management systems for securing content transmitted through communication networks, such as the Internet, are becoming well known. Rights management systems are needed because a fundamental problem facing content providers is how to prevent the unauthorized use and distribution of digital content. Unauthorized interception and access is exercebated because consumers can easily retrieve content, and technology is available for perfectly reproducing content.

A number of mechanisms have been developed to protect against unauthorized access and duplication and to provide digital rights management. One method is a digital rights management system that allows a set of rules to determine how the content is used. Another method (for software) for curbing unauthorized duplication is the use of a scheme which provides software tryouts or demos that typically work and expire after a specific duration. Further, an alternate scheme requires the presence of a license on a consumer terminal before the content can be viewed.

Many of the aforementioned schemes are typically implemented using “encryption/decryption” of the digital content. Encryption is the conversion of data into an unintelligible form, e.g., ciphertext, that cannot be easily understood by unauthorized consumers. Decryption is the process of converting encrypted content back into its original form such that it becomes intelligible. Simple ciphers include the rotation of letters in the alphabet, the substitution of letters for numbers, and the “scrambling” of voice signals by inverting the sideband frequencies. More complex ciphers work according to sophisticated computer algorithms that rearrange the data bits in digital information content.

In order to easily recover the encrypted information content, the correct decryption key is required. The key is a binary string that is required as a parameter to both encryption and decryption algorithms. Generally, the larger the key, the more difficult it becomes to decode the communications without access to the key. Generally, there are two types of schemes for encryption/decryption systems, namely (1) PKS (public key systems) or asymmetric systems which utilize two different keys, one for encryption, or signing, and one for decryption, or verifying; and (2) nonpublic key systems that are known as symmetric, or secret key, systems in which typically the encryption and decryption keys are the same. With both public and secret keys systems, key management must be employed to distribute keys and properly authenticate parties for receiving the keys.

One related art key management system developed at MIT is known as the Kerberos protocol. Kerberos is an authentication protocol allowing a party to access different machines on a network by using a KDC (key distribution center) and the concept of tickets. In general, a ticket is used to securely pass to a server the identity of the client for whom the ticket was issued. Disadvantageously, Kerberos is relatively complex and includes many different options, which are not always applicable to particular applications. Moreover, modifying such a complex system is no option because such modifications to an unfamiliar system add the risk of introducing additional errors. Another disadvantage of Kerberos is that the key management messages do not have sufficient information for the key exchange.

A growing interest in streaming distribution of multimedia content over Internet Protocol (IP) networks has resulted in a growing need for key management systems. One such streaming distribution system is the Aerocast Network™ developed by Aerocast, Inc. of San Diego, Calif. As discussed with reference to FIG. 1, although the existing phase 1 Aerocast Network facilitates delivery of content, it lacks security and key management for the network.

FIG. 1 is a block diagram of a network 100 (by Aerocast) for facilitating streaming of content over a communication network. Among other components, network 100 includes a content provider 102 for generating content intended for a consumer 116, Internet 114 through which content is streamed, and a central server 104 to which content provider 102 publishes its contents. Central server 104 contains a database 108 for storing content information, and a search engine 110 for searching database 108. Network 100 further comprises a provisioning center 106, and caching servers 112, 113 and 115.

In operation, consumer 116 wishing to access content by content provider 102, streams the content from the closest caching server, in this case, caching server 115. In conventional systems without caching servers, consumer 116 desiring such content streams obtains content directly from content provider 102. Not only does this result in poor content quality, delays associated with inadequate bandwidth may result. By using the caching servers, network 100 avoids disadvantages associated with direct streaming of digital content from content provider 102. Caching servers 112, 113 and 115 may be local DSL (digital subscriber line) providers, for example.

Network 100 provides a further advantage. When searching for content, consumer 116 need not search any and all databases on Internet 114. All content providers (including content provider 102) on network 100 publish descriptions of their content to a single central database 108. For video content for example, such descriptions may include the movie name, actors, etc. In this manner, when content is desired, consumer 116 uses search engine 110 to search database 108. When the content is found, database 108 thereafter provides a link to content provider 102 having the desired content. Content provider 102 is then accessed by consumer 116 to access the desired content in more detail. Such details include pricing information, etc.

A mechanism is provided whereby consumer 116 provides a list of caching servers closest to it to content provider 102. In response to consumer 116's request, content provider 102 selects the appropriate caching server closest to consumer 116 for streaming the content. It should be observed, however, that in today's Aerocast Network content is streamed in the clear by network 100. Disadvantageously, because it is unprotected, the content may be intercepted by an unauthorized consumer resulting in substantial losses to content providers and consumers.

Some of the disadvantages of network 100 are resolved by U.S. patent Ser. No. ______, entitled ______, commonly owned and concurrently filed herewith on ______, and hereby incorporated by reference as if set forth in its entirety in the present specification. Ser. No. ______ discloses a key management and authentication system for providing security to a network for streaming content.

To receive real-time data streams, a user typically requires a client for receiving the data stream from the content provider server. Only after the client is up and running and in communication with the server can it receive the real-time data stream. The client is obtained on-line on the content provider's web site, for example, or off-line via CD-ROMs. In either case, a lack of trust exists. After a client is obtained and ready to communicate, the server is unsure whether the client is an unauthorized user. For example, the client may have been altered or obtained from a source other than the server. Similarly, the client must verify that it is communicating with the server for which it was intended. Without such initial verification or authentication, an unauthorized user may be privy to confidential information and paid content resulting in relatively substantial losses to content owners.

A further disadvantage of conventional systems is that the provisioning server and the KDC (or some other key management server) are combined into a single server. Consequently, the KDC must be changed for new provisioning systems with different provisioning requirements.

Alternatively, conventional systems sometimes consist of a separate, non-integrated provisioning server and KDC that disadvantageously force a consumer to go through two separate registration screens—one for the provisioning server and a separate one for the KDC.

Therefore, there is a need to resolve the aforementioned problems relating to communication of data in networks (e.g. IP networks) and the present invention meets this need.

### BRIEF SUMMARY OF THE INVENTION

According to a first aspect of the present invention, a provisioning system that secures delivery of a client's public key to a KDC (Key Distribution Center) is disclosed. During registration, the provisioning system allows the initial establishment of trust between the client and the KDC server so the client can receive real-time data streams from a content provider. The KDC generates a provisioning key associated with the client ID, after which the provisioning key is forwarded to a provisioning server. Configuration parameters for initializing the client are generated by the provisioning server, the provisioning key being included in the configuration parameters. These parameters are used by the client for initialization. Upon initialization, the client generates a private/public key pair of which the public key is forwarded to the KDC. Advantageously, when forwarded, the public key is authenticated with the provisioning key previously received by the client.

According to another aspect of the present invention, a provisioning system that secures delivery of a client public key is disclosed. The provisioning system comprises a client that is to be registered; a provisioning server for registering the client and assigning it a unique user ID (identification); a key distribution center for generating a provisioning key associated with the user ID, the provisioning key being forwarded to the provisioning server; the provisioning server generating configuration parameters for initializing the client, the provisioning key being included in the configuration parameters; and upon initialization, the client provides a public key, authenticated with the provisioning key for forwarding to the key distribution center. (There are multiple ways for the client to obtain its public/private key pair: it can generate it during provisioning, get it from a cryptographic token, such as a Smart Card, or the keys can be pre-installed into the client in the factory).

According to another aspect of the present invention, the key distribution center stores the public key or generates a certificate.

According to another aspect of the present invention, the provisioning system further comprises a provisioning ticket in which the provisioning key is enclosed.

According to another aspect of the present invention, the provisioning system further comprises a provisioning ticket for forwarding the provisioning key to the client.

According to another aspect of the present invention, the method further comprises a ticket granting ticket obtained with the AS Request that is authenticated using a public key previously registered with the provisioning ticket, the ticket granting ticket used by the client for obtaining further tickets from the KDC, where each further ticket is used for obtaining access to a particular server.

According to another aspect of the present invention, the client further provides to the provisioning system a host identifier that uniquely identifies a computer on which the client application is running.

According to another aspect of the present invention, a method for initially establishing trust between a KDC and a client having a uniquely identifiable user ID (identification) is disclosed. The method comprises generating, by the KDC, a provisioning key associated with the user ID, the provisioning key being forwarded to the provisioning server; forwarding the provisioning key to a provisioning server for registering the client; generating, by the provisioning server, configuration parameters for initializing the client; forwarding to the client, the provisioning key and the configuration parameters for initializing the client; and upon initialization, generating by the client, a private and a public key, the public key being authenticated with the provisioning key for forwarding to the key distribution center.

According to another aspect of the present invention, the method further comprises a provisioning ticket for forwarding the provisioning key to the client.

Advantageously, unlike conventional systems which combine the provisioning server and the KDC (or some other key management server) into a single server, the KDC of the present invention is separate and generic and need not be changed for different provisioning requirements. Only the provisioning server need be changed when required. In addition, from a subscriber's perspective, registration occurs only once with the provisioning server since subsequent KDC registration is transparent to the subscriber.

### BRIEF DESCRIPTION OF THE DRAWINGS

FIG. 1 is a block diagram of a network for facilitating streaming of content over a communication network.

FIG. 2 is a block diagram of an IPRM (Internet protocol rights management) system incorporating the ES Broker™ protocol for applying key management and security to the network of FIG. 1 in accordance with an exemplary embodiment of the present invention.

FIG. 3 is a high-level flow diagram of the security and key management protocol when key management is initiated by a consumer (client) to a caching server (server) in accordance with an exemplary embodiment of the present invention.

FIG. 4 is a high-level flow diagram of the security and key management protocol when key management is initiated from a caching server (server) to a content provider (client) in accordance with an exemplary embodiment of the present invention.

FIG. 5 is a block diagram illustrating initial registration and the receipt of content by a consumer in accordance with an exemplary embodiment of the present invention.

A further understanding of the nature and advantages of the present invention herein may be realized by reference to the remaining portions of the specification and the attached drawings. Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, the same reference numbers indicate identical or functionally similar elements. Reference numbers differing by multiples of 100 indicate identical or functionally similar elements except as modified to accommodate the present invention.

### DETAILED DESCRIPTION OF THE INVENTION

Briefly, an exemplary embodiment of the present invention is a provisioning system that secures delivery of a client's public key to a KDC. The provisioning system permits initial establishment of trust between the client and the KDC (Key Distribution Center) server such that the client may receive real-time data streams from a content provider. Of course, the content provider is also a client of the KDC. The KDC generates a provisioning key associated with the client ID, after which the provisioning key is forwarded to a provisioning server. Configuration parameters for initializing the client are generated by the provisioning server, the provisioning key being included in the configuration parameters. These parameters are used by the client for initialization. Upon initialization, the client generates a private/public key pair of which the public key is forwarded to the KDC. The public key is authenticated with the provisioning key previously received by the client, when forwarded to the KDC.

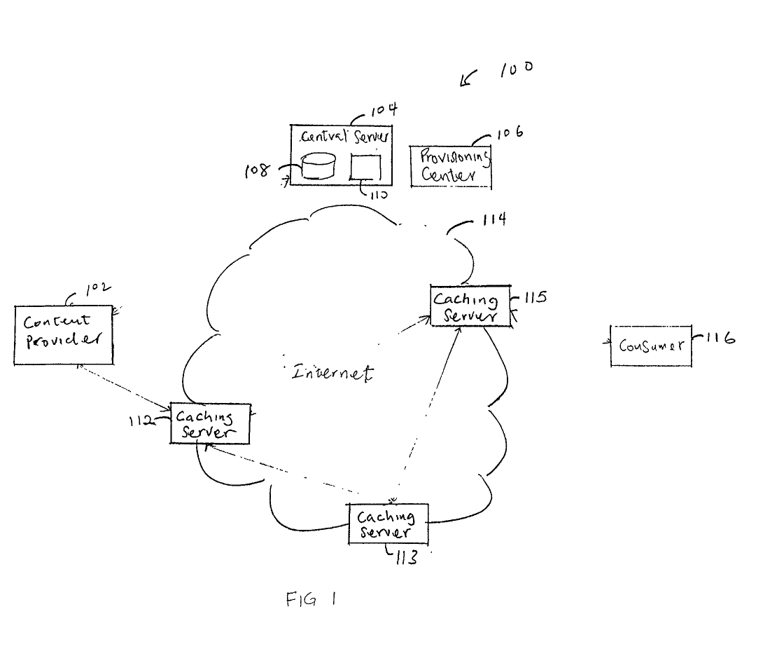

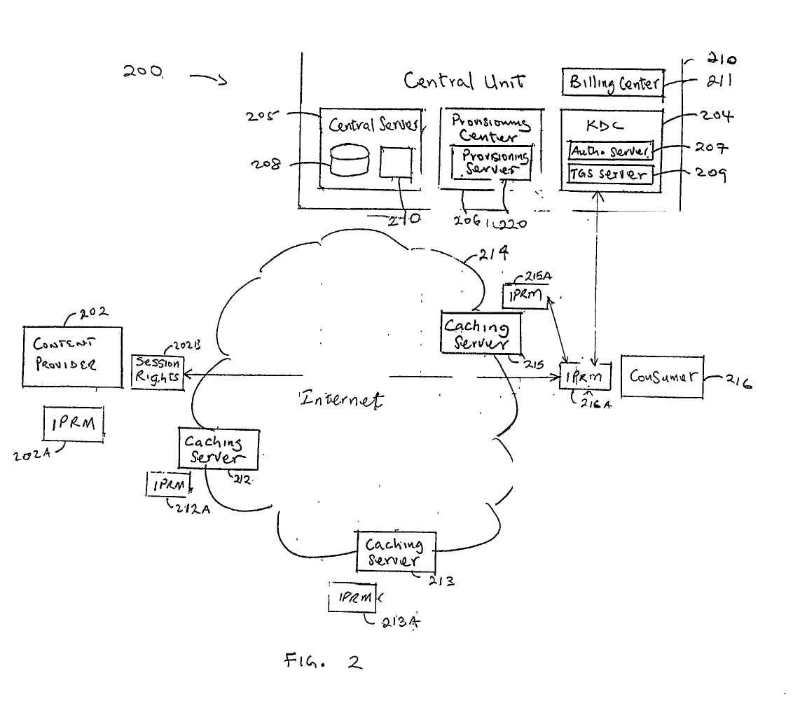

FIG. 2 is a block diagram of an IPRM (Internet protocol rights management) system 200 incorporating the ESBroker™ protocol for applying key management and security to network 100 of FIG. 1 in accordance with an exemplary embodiment of the present invention.

Among other components, IPRM system 200 comprises a content provider 202, consumer 216, Internet 214, a provisioning center 206, a central server 205 that contains both a database 208 and a search engine 210, caching servers 212, 213 and 215 all of which function in a similar manner to those of the corresponding components in FIG. 1. In addition, IPRM system 200 comprises a KDC 204 containing an AS (authentication server) 207 for issuing a TGT (ticket granting ticket) to consumer 216, a TGS (ticket granting server) 209 for providing server tickets to access particular servers, a provisioning server 220, and a billing center 211. KDC 204, billing center 211, provisioning center 206 and central server 205 are all located within a central unit 218 for facilitating provision of services within IPRM system 200.

Further, IPRM system 200 contains an IPRM agent 202A for administering rights management for content provider 202, a session rights object 202B for defining authorization data for content to be streamed, and/or consumer purchasing decision, and IPRM agent 212A for administering rights management for caching server 212, IPRM agent 213A for administering rights management for caching server 213, IPRM agent 215A for administering rights management for caching server 215, IPRM agent 216A for administering rights management for consumer 216, and a viewer (not shown) within consumer 216 for receiving desired content. Although not shown, the foregoing components may be located within their associated components. For example, IPRM agent 202A is locatable within content provider 202 rather than externally as shown.

As noted, IPRM system 200 generally functions to facilitate streaming of content in a secure fashion, to consumer 216 by using caching servers 212, 213 and 215. Content provider 202 provides content only once and thereafter it can be moved among the caching servers. The reason for the caching servers is to move the content closer to the edges of IPRM system 200. This improves the streaming performance and allows smaller content providers to sell their content without the need to buy expensive hardware for media streaming. It also allows introduction of an IP multicast (communication between a single sender and multiple receivers on a network) only at the caching servers. With current technology it is easier to have an IP multicast limited to a local access network than to have an IP multicast over the Internet.

The present invention in accordance with a first embodiment provides security to IPRM system 200 via KDC 204, IPRM agents 202A, 212A, 213A, 215A, and 216A. The IPRM agents in conjunction with KDC 204 and provisioning center 206 provide authentication, privacy, integrity, access control and non-repudiation tools to all aspects of IPRM system 200. For example, before a consumer can utilize the system for streaming content, a registration process is required. Secure registration for the consumer is provided by IPRM system 200. Thus, during the registration process, no one else may replicate the identity of consumer 216 by intercepting messages between consumer 216 and KDC 204. KDC 204 is a trusted entity and provides key distribution to network components using a blend of symmetric and asymmetric algorithms.

Another aspect of the system wherein security is provided is the interface between the caching servers and content provider 202, when content is communicated between the nodes. Other aspects to which security is provided are installation of caching servers, delivery of content to caching server from content providers, moving content between caching servers, reporting of usage data, billing, consumer profile update, content publishing, and initial consumer sign up. Although not indicated, one of ordinary skill in the art will realize that other aspects consistent with the spirit and scope of the present invention may be secured.

KDC 204 and the IPRM components may be purely protected software with a limited trust placed upon consumer 216, or may include hardware security modules, which may be mandatory to obtain rights to high quality content from copyright owners requiring high security levels, or the security may be implemented through a combination of both software and hardware. IPRM uses an authenticated key management protocol with high scalability to millions of consumers. The key management protocol is called ESBroker™ (Electronic Security Broker), a product of Motorola, Inc., San Diego Calif., and will be referenced throughout this specification.

The ESBroker™ protocol, partly based on the Kerberos framework, consists of client interactions with the centralized KDC 204 as well as with the individual application servers. A KDC client is any host that can send requests to the KDC. Within the IPRM system this includes consumers, caching servers and other IPRM system components. An application server is any server registered with the KDC for which a client might request a service ticket (e.g. caching server, Billing Center, etc.).

As used herein, a ticket is an authentication token that is given out to a client by the KDC. At a minimum, a ticket contains the name of the client, name of a specific server and a session key (a symmetric encryption key). The client name and session key need to be kept secret and are encrypted with another key, called a service key. The service key is a secret key that is known only to the KDC and a particular server named in the ticket. Because the client does not also possess this service key, it does not have the ability to decrypt the ticket and change its contents. Normally, the client also needs to know the session key and since it cannot get it out of the ticket, the KDC sends to this client a separate copy of the same session key.

In order to authenticate a message with a ticket (e.g. ESBroker Key Request message), a client would include in this message both a ticket and a checksum that is keyed with the session key. When the server named in the ticket receives this message from the client, it is able to decrypt the ticket with its service key, verify the client name and obtain the session key. The session key is then subsequently used to verify the keyed checksum and thus authenticate the whole message. This ticket-based authentication is part of the Kerberos IETF standard (RFC 1510) and is also utilized in the ESBroker protocol. A ticket may have other information as well, including a validity period (start time and expiration time), various flags, client authorization data, etc.

The same host may be both a KDC client and an application server at time. For the IPRM system 200, the protocol employs a series of messages to accomplish key management between client and server interfaces of the system. This key management protocol is intended to be of general use for establishing secure sessions and is restricted to the IPRM system. These messages listed in Table 1 below, are further d in the section entitled IPRM Protocol Messages.

TABLE 1

| Code | Message Type | Description |
|---|---|---|
| 1 | CLIENT_ENROLL_REQ | Client enrollment request, |
| | | containing client public key and |
| | | other attributes. |
| 2 | CLIENT_ENROLL_REP | Client enrollment reply from |
| | | KDC 204, possibly containing a |
| | | client certificate for the public |
| | | key. |
| 3 | AS_REQ | Request Ticket Granting Ticket |
| | | from the Authentication Server. |
| 4 | AS_REP | Reply from Authentication |
| | | Server with the TGT. |
| 5 | TGS_REQ | Request service ticket from TGS |
| | | server 209. |
| 6 | TGS_REP | Reply from TGS server 209 with |
| | | the service ticket. |
| 7 | TKT_CHALLENGE | Server requests this client to |
| | | initiate key management. |
| 8 | KEY_REQ | Key Management request from |
| | | client. |
| 9 | KEY_REP | Key Management reply from the |
| | | application server. |
| 10 | SEC_ESTABLISHED | An ACK from client to an |
| | | application server stating that |
| | | security is established. |
| 11 | ESB_ERR | Error reply message. |
| 12 | INIT_PRINCIPAL_REQ | Create a provisioning ticket for a |
| | | specified principal. If the |
| | | specified principal doesn't |
| | | already exist, it will be |
| | | initialized in KDC 204 database. |
| 13 | INIT_PRINCIPAL_REP | Returns a provisioning ticket for |
| | | the specified principal. |
| 14 | DELETE_PRINCIPAL_REQ | Delete a specified ESBroker ™ |
| | | principal from KDC 204 |
| | | database. |
| 15 | DELETE_PRINCIPAL_REP | Acknowledgment to |
| | | DELETE_PRINCIPAL_REQ. |
| 16 | SERVICE_KEY_REQ | Application server requests a |
| | | new service key from KDC 204. |
| 17 | SERVICE_KEY_REP | KDC 204 returns a new service |
| | | key to the application server. |
| 18 | AUTH_DATA_REQ | KDC 204 requests authorization |
| | | data for a particular principal. |
| | | This may be part or all of the |
| | | authorization data that will |
| | | appear in a ticket that KDC 204 |
| | | subsequently issues. |
| 19 | AUTH_DATA_REP | Authorization Sewer returns the |
| | | data requested with |
| | | AUTH_DATA_REQ. |

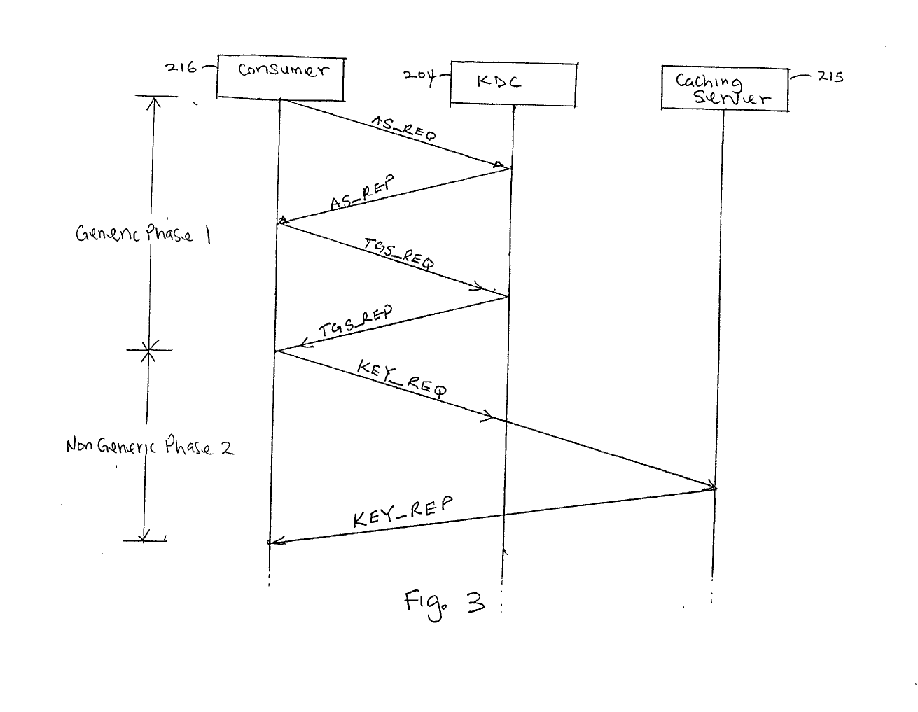

In operation, the key management process between a client and a server is classified in two phases: (1) a generic phase in which a client is in contact with KDC 204 to obtain a server ticket to access the server; and (2) a non-generic phase in which the client uses the server ticket to form a KEY_REQ (key request) message to the server. In the non-generic phase, a DOI (domain of interpretation) object containing information that is specific to a particular application of a general ESBroker™ key management protocol (e.g. specifically for the IPRM System) is obtained. For example, in a key management process between consumer 216 (client) and caching server 215 (server), the generic phase involves obtaining, by consumer 216, a server ticket from KDC 204 for accessing caching server 215. The non-generic process involves using the server ticket to generate the KEY_REQ message for accessing caching server 215, wherein the KEY_REQ contains the DOI object that contains the Session Rights. Furthermore, which messages are used in the protocol depend on whether key management is client or server initiated. If server initiated, the TKT_CHALLENGE (ticket challenge) message is employed in addition to other messages as more clearly shown with reference to FIG. 3.

FIG. 3 is a high-level flow diagram of the security and key management protocol when key management is initiated by consumer 216 (client) to caching server 215 (server) in accordance with an exemplary embodiment of the present invention.

As shown, consumer 216 wishing to stream content from caching server 215 in a secure manner initiates the key management process. This is done by transmitting an AS_REQ message to KDC 204 to obtain a TGT (ticket granting ticket) for caching server 215. The AS_REQ message contains the consumer 216's identity, KDC 204's identity, more specifically the KDC realm or administrative domain, and a nonce to tie it to a response. It may also contain a list of symmetric encryption algorithms that are supported by consumer 216. Of course, it is assumed that both consumer 216 and caching server 215 have been registered by KDC 204 which acts as a trusted authenticator and can verify the identity of both nodes.

As shown, in response to the AS_REQ message, KDC 204 validates the TGT request, checks with provisioning server 220 for validity of consumer 216 and thereafter responds with an AS_REP message containing the TGT. It should be noted that the private portion of the TGT is encrypted with KDC 204's service key known only to KDC 204. The same KDC 204 service key is also used to authenticate the TGT with a keyed hash. Since consumer 216 does not know KDC 204 service key, it cannot modify it and cannot read the private part of the ticket. Because consumer 216 still needs to know the session key for subsequent authentication to KDC 204, another copy of the session key is delivered to consumer 216 using a key agreement algorithm (e.g., Elliptic Curve Diffie-Hellman).

After receiving and storing the TGT, consumer 216 is ready to start requesting streaming content on this network. A. TGS_REQ message containing the TGT is sent to KDC 204 (TGS server 209) requesting a ticket for caching server 215. It should be noted that consumer 216 might perform additional provisioning actions, such as subscribe to a particular content provider. Also, consumer 216 may create a list of preferred caching servers.

Responsive to the TGS_REQ message, a TGS_REP message having the caching server ticket is transmitted to consumer 216 from KDC 204. If there are additional preferred caching servers, consumer 216 may contact KDC 204 to obtain caching server tickets for the preferred caching servers using the TGT. These caching server tickets may then be cached for later use. Otherwise, the caching server tickets are obtained at the time of requesting the content from the appropriate caching server.

For some consumers, KDC 204 first needs to query provisioning server 220 for subscriber authorization data before issuing the caching server tickets. This is accomplished with an AUTH_DATA_REQ/AUTH_DATA_REP exchange between KDC 204 and the provisioning server 220. The user authorization data is insertable into the tickets. The caching server ticket has the same format as the TGT—it includes a session key used for authentication to the caching server 215. The private part of the ticket is encrypted with caching server 215's service key known only to it and KDC 204. The ticket is also authenticated with a hash that is keyed with the same service key. As is the case with the TGT, consumer 216 is not able to modify this ticket. Consumer 216 needs the session key from the caching server ticket to authenticate itself to this server. A copy of this session key is delivered to consumer 216, encrypted with the TGT session key.

This process beginning with the AS_REQ message to the TGS_REP message corresponds to the generic phase noted above wherein a client is in contact with KDC 204 to obtain a server ticket to access the server. Because it is generic, the same process is used to secure other interfaces for delivery of content from content provider to caching servers; reporting of usage; billing, etc. Further, this results in a more secure IPRM system without the need for unnecessary or complex options. Moreover, because of the reduction in complexity, problems are identified and rectified in an expeditious fashion.

Upon receiving the TGS_REP message containing the caching server ticket, a KEY_REQ message with the ticket is sent to caching server 215. The KEY_REQ message contains a MAC (message authentication code) of the message, DOI (domain of interpretation) object and a time stamp in addition to the caching server ticket. A DOI object is for carrying application specific information associated with this secure session. In the present embodiment, the DOI object contains session rights information and consumer purchase decision information for consumer 216. The reason for encapsulating the session rights and purchase decisions into this DOI object is because the session rights are specific to this particular content delivery architecture (with caching servers), while the ESBroker™ protocol provides generic key management services. ESBroker™ could be applied to other types of secure sessions, with their application-specific information also encapsulated in a DOI object.

When caching server 215 receives the generic KEY REQ message, it extracts the non-generic DOI object. Caching server 215 then checks application specific code for streaming, for example, verifies the DOI object, and authorization information. If the session rights, etc. match the authorization data in the ticket, a KEY_REP message containing a session key is forwarded to consumer 216. From that point, both sides have a protocol key and can start encrypting their final messages such as streaming content. If authorization fails, an error message is forwarded to the consumer. It should be noted that in some instances, the KEY_REP message contains a generic DOI object where caching server 215 needs to return some application specific information to consumer 216. For example, in the IPRM system, when the caching server sends a Ticket Challenge to the content provider to request a secure session, the session ID is provided later by the caching server, inside the DOI object in the KEY_REP message. The Ticket Challenge message is not authenticated and therefore does not contain a DOI object.

This phase (KEY_REQ/KEY_REP) corresponds to the non-generic phase in which the client uses the server ticket to form a key request to the server. This phase is non-generic because the DOI object varies depending on the interface being secured. For example, the DOI object relating to delivery of content from content provider to caching servers is different from that employed for delivery of the same content from a caching server to subscribers.

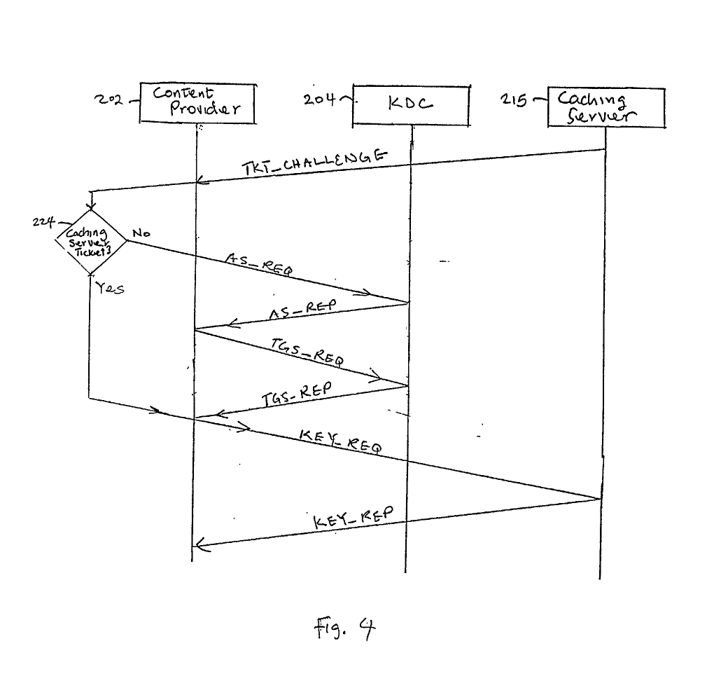

FIG. 4 is a high-level flow diagram of the security and key management protocol when key management is initiated from caching server 215 (server) to content provider 202 (client) in accordance with an exemplary embodiment of the present invention.

Key management is initiated by caching server 215 when a request for content is received and caching server 215 does not have the requested content. As shown, key management is initiated by sending a TKT_CHALLENGE (ticket challenge) message from the caching server 215 to content provider 202. The TKT_CHALLENGE is for use by a server to direct a client to initiate key management.

At decision block 224, if content provider 202 has a previously obtained caching server ticket, it forwards a KEY_REQ message containing the ticket to caching server 215. In response, caching server 215 sends a KEY_REP message as previously discussed above. On the other hand, returning to decision block 224, if content provider 202 has no caching server ticket and no TGT, it sends an AS_REQ message to KDC 204 which replies with an AS_REP message. If the content provider has its TGT the AS_REQ/REP is skipped.

Thereafter, content provider 202 sends a TGS_REQ message to KDC 204, and receives a TGS_REP message containing the caching server ticket. When the caching ticket is obtained, content provider 202 sends a KEY_REQ message in this case with no DOI object. The session ID may be either in the reply or the request or both; session rights do not apply since neither content provider 202 nor caching server 215 is a consumer. Once the shared key is established, SEC_ESTABLISHED message (not shown) is sent to caching server 215 by content provider 202. Since the server initiated key management, the SEC_ESTABLISHED message informs the server that security has been established.

Advantageously, it should be observed that the same messages namely TKT_CHALLENGE, AS_REQ/AS_REP, TGS_REQ/TGS_REP, KEY REQ/KEY_REP, SECURITY_ESTABLISHED are used in multiple protocols and scenarios depending on whether a client or server initiates key management. If the server requests key management, all of the messages are used including the TKT_CHALLENGE message. Contrawise, if the client initiates key management all messages other than the TKT_CHALLENGE are employed. It should be observed that the Security Established message is also commonly skipped when client initiates key management. Advantageously, because a single key management protocol is utilized on all interfaces, it is easier to analyze whether the system is secure. In addition, the system secures both streaming content and non-streaming content including billing data with the same key management with changes only to the DOI object field.

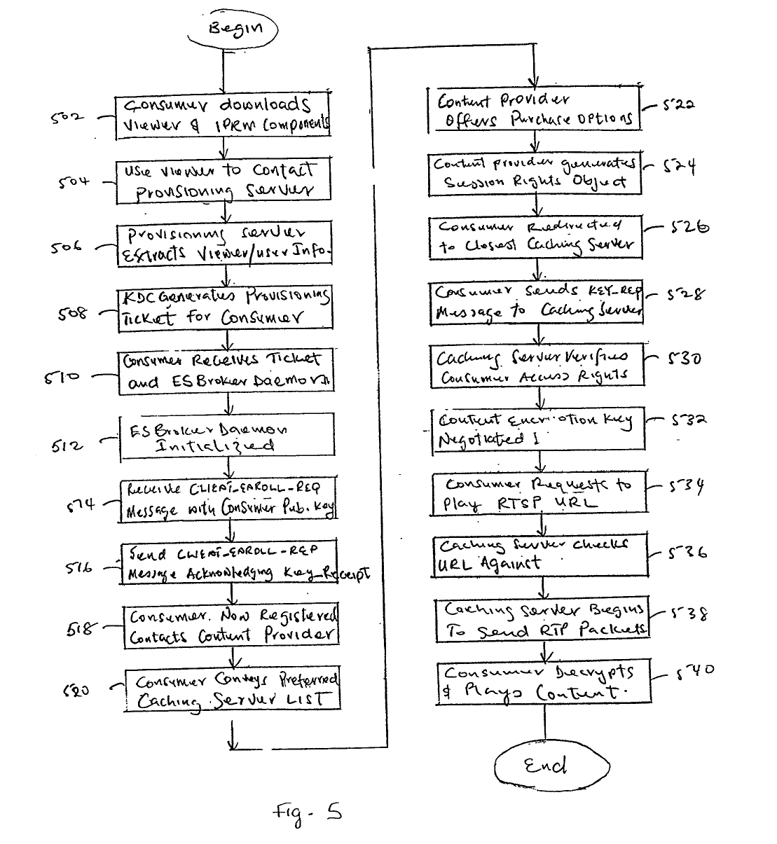

FIG. 5 is a block diagram illustrating initial registration and the receipt of content by consumer 216 in accordance with an exemplary embodiment of the present invention.

A new consumer 216 wishing to receive content from caching server 215 may initially sign up with central unit 218.

At block 502, consumer 216 using a web browser accesses a web site (not shown) provided by central unit 218. Consumer 216 comes to the initial sign-up and software download page, downloads and installs a viewer application, including any IPRM components. Alternatively, the viewer application and IPRM components could be distributed to consumers using a removable media, such as a CD-ROM.

At block 504, consumer 216 begins a registration process by starting up the viewer to initiate an SSL (secured socket layer) session with provisioning server 220. During the startup of the session, the central unit sends its certificate to the client, allowing the client to validate the central unit's identity. This certificate contains the public key of the central unit and would normally be signed by a well-known Certification Authority that is trusted by the client (e.g. Verisign). The client is able to validate the central unit certificate, because it is pre-configured with the public key of this well-known Certification Authority. After the SSL session begins, consumer 216 fills out the initial signup form, which includes a form for a user ID. Alternatively, the user ID may be automatically assigned by the central unit 218. Consumer 216 next determines a local host identifier and sends it to provisioning server 220 along with other information. (This is done transparently by the viewer.)

At block 506, provisioning server 220 extracts the user ID and converts it to an ESBroker™ principal name. A principal name is a uniquely named consumer or server instance that participates in IPRM system 200. In this case, the viewer principal name is the same as a subscriber id assigned to that viewer. After the user ID is converted to an ESBroker™ principal name, provisioning server 220 sends an INIT_PRINCIPAL REQ message to KDC 204 to generate a new ESBroker™ principal in KDC 204 database (not shown). This message also includes a host identifier for consumer 216.

At block 508, KDC 204 generates a provisioning ticket containing a provisioning key (session key) for consumer 216. The provisioning key may be a symmetric key in one embodiment of the present invention. The provisioning key is used by KDC 204 for authentication of messages between itself and consumer 216. Thereafter, the provisioning ticket is returned to provisioning server 220 along with an SKS (Session Key Seed). Because consumer 216 has no access to the provisioning key (encrypted with a KDC 204 key), the SKS is used by consumer 216 to reconstruct the provisioning key located within the provisioning ticket.

At block 510, in addition to the provisioning ticket, configuration parameters including the user ID, ticket expiration time (already included in the non-encrypted part of the ticket), KDC 204 name and/or address etc. and (optionally) software components including an ESBroker™ daemon are downloaded by consumer 216. It should be observed that the software components might have been downloaded prior to the registration procedure, as is the case in the Aerocast Network.) Thereafter, the SSL connection is terminated.

At block 512, the ESBroker™ daemon is initialized using the downloaded configuration parameters. At this point, consumer 216 wishes to receive content from a specific caching server.

At block 514, a public/private key pair for authenticating AS_REQ messages between consumer 216 and KDC 204 is generated. The public key is forwarded to KDC 204 from consumer 216. This is accomplished using a CLIENT_ENROLL_REQ message. The message contains the public key (symmetrically) signed with the provisioning key derived from the SKS by consumer 216. Since there is no access to the provisioning key within the provisioning ticket, consumer 216 derives the provisioning key from the SKS using a one-way function.

The problem with distributing tickets and provisioning keys to software clients is that a software client may copy the ticket and key for forwarding to an unauthorized software client. To address this problem, consumer 216 receives the SKS instead of the actual provisioning key. Combining SKS with a unique host identifier using a one-way function generates the provisioning key. The host identifier must be a value that is automatically determined by the consumer's software application based on the local hardware configuration. The choice of the host identifier must be such that it is very difficult for a hacker to change. For example, it can be a CPU serial number or other type of unmodifiable identifier associated with a piece of hardware. The resulting session key that is derived from the SKS and this host identifier will be specific to a particular host and cannot be used anywhere else. In the present embodiment, consumer 216 executes the following function to reproduce the provisioning key:

Provisioning key=SKGen(Host ID, SKS):

Where SKGen ( ) is a one-way function; SKGen⁻¹( ) cannot be calculated within reasonable amount of time (e.g. in less than the ticket lifetime).

At block 516, upon receiving the CLIENT_ENROLL_REQ message, KDC 204 finds consumer 216 in its local database to verify the request. If the request is valid, KDC 204 stores the public key either in a client database that could be located locally on the KDC or at some other remote location with secure access. Alternatively, KDC 204 may generate a certificate with the public key for forwarding to consumer 216. A message CLIENT_ENROLL_REP acknowledging the key has been stored (or alternatively containing a client certificate) is then forwarded to consumer 216.

At block 518, consumer 216 is now enrolled and may contact a web site (not shown) with a database 208 having a listing of content from various providers including content provider 202. When the desired content is located, consumer 216 gets redirected to content provider 202.

At block 520, consumer 216 then contacts content provider 202 to which it was redirected and conveys its preferred list of caching servers, list of subscribed services, its ability to pay for content, etc.

At block 522, content provider 202 offers an optimized subset of purchase options that depend upon the context of the particular consumer and service. For example, price selection screens may be bypassed for consumers already subscribed to this service.

At block 524, content provider 202 generates a session rights object that encapsulates the purchase options selected by consumer 216, an optional set of content access rules (e.g., blackout regions) and a reference to the selected content. For example, a session ID which is a random number that was generated by consumer 216 when it requested these session sights from the content provider. An end time after which these session rights are no longer valid, a ProviderID, PurchaseOption selected by consumer 216, etc.

The set of content access rules is optional because it might have been delivered directly to caching server 215 with the content. Furthermore, caching server 215 can optionally gather additional content access rules from multiple sources. For example, an access network provider (e.g. cable system operator) might impose some restrictions for delivery over its network.

At block 526, content provider 202 redirects consumer 216 to the appropriate caching server. In this case, content will be streamed from caching server 215 which is closest to consumer 216. If consumer 216 had previously cached a caching server ticket for caching server 215 when it signed up, it retrieves that ticket. If it has no cached ticket, it contacts KDC 204 using a TGT to obtain the correct caching server ticket.

At block 528, consumer 216 authenticates itself to caching server 215 using the caching server ticket, and at the same time (in the same KEY_REQ message) forwards the session rights object obtained from content provider 202 to caching server 215. Communication between consumer 216 and caching server 215 is accomplished using the KEY_REQ/KEY_REP messages above.

At block 530, caching server 215 checks the access rules from the session rights object against consumer 216's entitlements contained in the ticket and also against the user selection (purchase option selected by the consumer) in the session rights object. The entitlements are basically authorization data specific to consumer 216 which allows access to content.

The content access rules could have been stored locally by caching server 215 and not present in the session rights object. Access rules are checked against the authorization data and also against the user selection (purchase option selected by the consumer) contained in the session rights object.

At block 532, if access is approved, consumer 216 and caching server 215 negotiate a Content Encryption Key (CEK) for delivery of the content.

At block 534, consumer 216 starts issuing encrypted RTSP commands to the caching server 215 to get description of the content (RTSP URL) and then to request to play the content.

At block 536, caching server 215 receives RTSP commands, decodes them and returns encrypted RTSP responses. When an RTSP command requests to play a specific URL, caching server 215 verifies that the specified URL is what was specified in the session rights object for this secure session (identified by a Session ID).

At block 538, after receiving a request to play an RTSP URL, caching server 215 begins to send out encrypted RTP packets and both caching server 215 and consumer 216 periodically send encrypted RTCP report packets. All RTP and RTCP packets associated with the same streaming session and with a particular RTSP URL are encrypted using the same set of keys that are associated with a single Session ID, the Session ID that was recorded when caching server 215 started receiving encrypted RTSP messages from consumer 216.

At block 540, consumer 216 decrypts and plays the content. At the same time, consumer 216 may issue additional RTSP commands (e.g. to pause or resume content play out), still encrypted using the same set of keys that are associated with the Session ID assigned to this streaming session. Caching server 215 keeps track of who viewed the content, how long the content was viewed, and under what mechanism the content was purchased. This information is then used for billing purposes, whether directed to consumer 216 or to the advertiser. Advantageously, the present system allows an effortless transition through multiple content from various providers and with billing information such as a credit number entered only once. When content is requested, information about the consumer is being transmitted transparently to the content provider. The consumer experience is relatively effortless because multiple access codes need not be remembered.

### IPRM Protocol Messages

The following are exemplary ESBroker™ messages employed in the initial registration process, as listed in Table 1. Other ESBroker™ messages are described in U.S. Ser. No. ___, concurrently filed herewith on ______, and entitled KEY MANAGEMENT PROTOCOL AND AUTHENTICATION SYSTEM FOR SECURE INTERNET PROTOCOL RIGHT S MANAGEMENT ARCHITECTURE, which is hereby incorporated by reference as if fully set forth in the present invention.

### Message CLIENT_ENROLL_REQ

The message CLIENT_ENROLL_REQ is sent to KDC 204 by a client that wants to update its public key or specify a new public key that is not yet in KDC 204 database and does not have a corresponding digital certificate. This message may be authenticated with a provisioning ticket and a checksum that is keyed with the provisioning key (the session key in the provisioning ticket). (In order to generate this keyed checksum, the client has to obtain the second copy of this session key outside of the provisioning ticket.) A provisioning server may obtain a provisioning ticket and the second copy of the provisioning session key on behalf of some ESBroker™ principal using an INIT_PRINCIPAL_REQ message. A provisioning server would then use an out-of-band method of forwarding the provisioning ticket and the second copy of the corresponding Provisioning Key to consumer 216, which will then generate this CLIENT_ENROLL_REQ.

The client may also specify which type of KDC 204 certificates it would accept. If the corresponding attribute (KDC CertificateType) is not present, consumer 216 does not support any kind of KDC 204 certificates (in which case the client is provisioned with the KDC public key without a certificate).

Upon receiving this message, KDC 204 will decide based on its policy if it should store the client public key, issue to the consumer a certificate validating this public key or both. KDC 204 will also decide what type of certificate to issue. The client indifferent about the kind of certificate issued by KDC 204 because it does not have to parse 5 its own certificates. When a consumer is issued a certificate, it has to treat it as an opaque blob. The client is responsible only for storing its own certificate. The following are attributes of the CLIENT_ENROLL_REQ message.

TABLE 2

| Attributes | Description |
|---|---|
| Ctime | Current time on client's host. |
| PublicKeyInfo | The consumer's public key that will be used by |
| | KDC 204 to verify signatures on AS_REQ |
| | messages from this client. |
| KDCCertificateType | Identifies the type of KDC 204 certificates that the |
| | client is able to process (in AS_REP). This field is |
| | optional; if it is not present, the client does not |
| | accept KDC 204 certificates. |
| ServiceTicket | The provisioning ticket obtained from the |
| | INIT_PRINCIPAL_REP. It identifies the client |
| | and provides a session key for computing the keyed |
| | checksum in the Signature attribute. |
| Signature | Keyed checksum over this message. It is keyed with |
| | an already provisioned client symmetric key. If this |
| | client is also an application server, this symmetric |
| | key may be the same as the service key. |

### Message CLIENT_ENROLL_REP

This message is a reply to CLIENT_ENROLL_REQ. It either acknowledges the client public key has been updated or specifies a new client certificate for the public key or both. The action taken by KDC 204 before sending this message is based on its configured policy. This message is authenticated with a keyed checksum, using the same Provisioning Key that was used to authenticate the request. Table 3 is a list of attributes for this message.

TABLE 3

| Attributes | Description |
|---|---|
| Cname | Name part of the client's principal identifier. |
| Crealm | Realm part of the client's principal identifier. |
| ClientInfoUpdated | This is a Boolean flag: |
| | 1 = KDC 204 updated client info in its database |
| | 0 = Database not updated—the client must always |
| | use the issued certificate. |
| EndTime | This field specifies the expiration time of the client's |
| | public key. After this time KDC 204 will no longer |
| | accept signatures with the corresponding private |
| | signing key. In the case that the client is issued a |
| | certificate, the certificate expiration time must be |
| | equal to this value. The value of this field may be 0, |
| | meaning that the key has no expiration time. |
| CertificateChain | This chain ends on a client certificate issued by |
| | KDC 204 for the specified public key. Other |
| | certificates in the chain (if any) may be needed to |
| | complete client authentication when it issues an |
| | AS_REQ to a KDC 204 in a different realm. |
| Signature | Keyed checksum over this message. It is keyed |
| | with the provisioning key—session key from the |
| | provisioning ticket in the |
| | CLIENT_ENROLL_REQ. |

### MESSAGE INIT_PRINCIPAL_REQ

The message INIT_PRINCIPAL_REQ can be sent to KDC 204 by a special client principal with administrative privileges and is used to initialize a new ESBroker™ principal entry in KDC 204 database. If an entry with the same principal name already exists, only the provisioning ticket will be issued.

The main purpose of this message is to automate KDC 204 administration and to integrate it with external provisioning systems. It is intended that a principal entry in KDC 204 database would contain only cryptographic keys and policy associated with ticket issuance. There would likely be an additional database, external to KDC 204 that keeps additional subscriber information. This message allows an administrative client for this other external database to automatically create entries in KDC 204 corresponding to new subscribers in the external database.

Also, when an existing principal wishes to change its public key in KDC 204 database, it would need the Provisioning System to send this request on its behalf—in order to generate a new provisioning ticket. A provisioning ticket normally has a short lifetime and usually a new Provisioning Key (session key inside provisioning ticket) is needed for each CLIENT_ENROLL_REQ to update a public key.

It is assumed that such updates are relatively infrequent and for that reason the message is protected with a digital signature. This simplifies the administrative interface—an administrative client is not required to first obtain a ticket for KDC 204. Also, a digital signature provides proof that a particular administrative client generated the database update request.

This message also contains the client's key agreement parameters (similar to the AS_REQ). A key agreement algorithm is utilized to generate a symmetric encryption key that will be used to encrypt a portion of the subsequent INIT_PRINCIPAL_REP message. (The INIT_PRINCIPAL_REP contains a Provisioning SKS that requires secrecy.)

The KDC 204 is assumed to be a better source of random numbers than the administrative client and therefore this INIT_PRINCIPAL_REQ message does not itself contain any secret keys. All secret keys that need to be generated for this new principal are generated by KDC 204. Table 4 is a list of attributes for this message.

TABLE 4

| Attributes | Description |
|---|---|
| Cname | Name of the principal that is to be initialized in |
| | KDC 204 database. Note that this is not the same |
| | principal as the one that sent the message. The name |
| | of the sender is inside ESBPubKeyClientAuthen- |
| | ticator. |
| Crealm | Realm part of the principal that is to be initialized |
| | in KDC 204 database. |
| HostID | Unique host identifier for the to-be-initialized client. |
| | This is a variable-length field, the format of |
| | which may be dependent on a particular client |
| | operating system or even on the client hardware |
| | configuration. If this request is for an existing |
| | principal, this host identifier replaces the currently |
| | stored value in KDC 204 database. |
| EncTypeSet | Types of encryption supported by the administrative |
| | client in preference order. |
| KeyAgreementInfo | Describes key agreement algorithm type and |
| | attributes required for the algorithm. |
| ESBPubKeyCli- | This attribute is used to authenticate the |
| entAuthenticator | administrative client identity as well as this request |
| | message. It includes client principal name, |
| | timestamp, digital signature and optional certificate |
| | chain. Also includes an identifier of KDC 204's |
| | public key that should be used by KDC 204 to sign |
| | the reply. |

### Message INIT_PRINCIPAL_REP

This message is a reply to INIT_PRINCIPAL_REQ. It acknowledges that the new principal record has been created and contains the corresponding provisioning ticket. The reply also includes the private part of the ticket encrypted using a key agreement algorithm—so that the client knows the session key inside this ticket. Note that as is the case with AS_REP and TGS_REP messages, the encrypted portion of the reply contains the SKS (Session Key Seed) instead of the actual Session Key. The client being initialized (which is not the administrative client receiving this reply) is expected to reconstruct the session key from the SKS and its host identifier.

If a principal record with the specified name already existed, then this message specifies a new provisioning ticket created for an existing principal. Before this ticket expires, it should be used by the principal specified in the ticket to authenticate a CLIENT_ENROLL_REQ. This message is authenticated with a digital signature using KDC 204's private key. Table 5 is a list of attributes for this message.

TABLE 5

| Attributes | Description |
|---|---|
| ServiceTicket | The provisioning ticket used to authenticate |
| | CLIENT_ENROLL_REQ messages. The server |
| | principal name in this ticket is ‘ESBadmin’ (taken |
| | without quotes). |
| EncryptedData | This field contains the same information as the |
| | PrivateTicketPart in the provisioning ticket with the |
| | exception of the session key - it is replaced with the |
| | SKS. The encrypted data is of type |
| | PrivateTicketPart and is encrypted with a symmetric |
| | key derived from the key agreement algorithm. |
| KeyAgreementInfo | Describes the type of the key agreement algorithm |
| | and public attributes of the algorithm. |
| ESBPubKeyK- | Authenticates KDC 204 with a digital signature and |
| DCAuthenticator | optional certificate chain. |

### Generation of INIT_PRINCIPAL_REP

If the INIT_PRINCIPAL_REQ processing does not generate any error, KDC 204 generates an INIT_PRINCIPAL_REP using the following procedure: (1) The STID header field from INIT_PRINCIPAL_REQ message is copied into the DTID header field in the INIT_PRINCIPAL_REP, to tie it to the request; (2) The KDC 204 assigns the type of the random provisioning ticket session key based on the intersection of the list of methods in the EncTypeSet field with the list of encryption methods supported by KDC 204. If this intersection contains more than one encryption algorithm, KDC 204 selects the strongest one.

As used herein, an STID (Source Transaction Identifier) is a unique random value chosen by the initiator of a key management message. It is used to match request/response pairs. A responder will take STID and put it in the DTID field in the header. When the sender of the original request gets a response, it will verify that DTED in the response matches up against the original STID value. A DTID (Destination Transaction Identifier) is a value used in reply messages and so an original request would have DTID as empty. The responder will take STID from the request and put it into DTID in the reply. In the case of more complicated 4-message transactions, message #2 for example would have both STID and DTID fields filled in. DTID would be STID from the previous message and STID would be some new random value that would be used to match this message to the following message #3.

Step (3), randomly generate an SKS—Session Key Seed. SKS of the same size as the provisioning ticket's session key. (4) Using the Host ID for the specific KDC 204 client and the SKS generated in the previous step, compute: Session Key=SKGen(Host ID, SKS). (5) KDC 204 generates a provisioning ticket. (6) KDC 204 secret key is used to encrypt the encrypted ticket part and also generate a keyed checksum over the whole ticket. The server principal name in the ticket is ‘ESBadmin’ (taken without quotes). The client name in the ticket was specified in the INIT_PRINCIPAL_REQ and it is not the same as the name of the administrative client that sent the INIT_PRINCIPAL_REQ message. The end time of the ticket is determined by KDC 204.

Step (7), the EncTypeSet field from the INIT_PRINCIPAL_REQ is used by KDC 204 to select the type of the key that is derived from the key agreement algorithm and then used for encrypting the EncryptedData portion of the reply. If there is more than one in the list, KDC 204 must choose the strongest encryption type in the EncTypeSet that it supports. (8) The encrypted portion of the reply contains the same information as the PrivateTicketPart of the provisioning ticket, except that the session key attribute contains the value of the SKS (instead of the actual session key that is in the ticket).

Step (9), generate ESBPubKeyKDCAuthenticator to authenticate the INIT_PRINICPAL_REP message. While generation of the INIT_PRINCIPAL_REQ message has been described specifically with respect to the present embodiment, one of ordinary skill in the art will realize that the description is applicable to other embodiments within the spirit and scope of the present invention. Moreover, generation of the INIT_PRINCIPAL message is similar to generation of other ESBroker™ messages although appropriate changes specific to the ESBroker™ message may be made.

### Processing of INIT_PRINCIPAL_REP

The administrative client employs the following procedure to process INIT_PRINCIPAL_REP. Note that the client does not send an error message back to the server. In some cases, the client retries with another INIT_PRINCIPAL_REP: (1) the message header is parsed. If the header parsing fails, it is assumed this reply was never received. (If there are any outstanding INIT_PRINCIPAL_REPs, waiting is continued for a reply until a time out and then retry.) (2) The protocol version number in the header is verified. If this protocol version is not supported, it is assumed the message was never received. (3) The client looks for an outstanding INIT_PRINCIPAL_REQ message with the STID value that matches the DTID header field in this reply. If there is no match, the client proceeds as if the message was never received. (4) The rest of the message is parsed. If the message format is found to be illegal, it is assumed the message was never received.

Step (5), the ESBPubKeyKDCAuthenticator is processed. (6) The administrative client decrypts the PrivateTicketPart in the reply, using the key agreement algorithm. If the PrivateTicketPart cannot be decrypted because the administrative client does not support the specified encryption type, a fatal error is reported to the user and the client does not retry. If the resulting clear text contains formatting errors or contains a client identity that does not match the request, a fatal error is be reported to the user and the administrative client does not retry.

Step (7), the administrative client forwards the provisioning ticket as well as the decrypted PrivateTicketPart to the client principal on whose behalf the ticket was issued. The method used to forward the information would use a secure interface that is out of scope for ESBroker™. For example, for a Web client it could be HTTP over SSL. While processing of the INIT_PRINCIPAL_REQ message has been described specifically with respect to the present embodiment, one of ordinary skill in the art will realize that the description is applicable to other embodiments within the spirit and scope of the present invention. Moreover, processing of the INIT_PRINCIPAL message is similar to generation of other ESBroker™ messages although appropriate changes specific to the ESBroker™ message may be made. For example, the AS_REQ message for requesting a ticket granting ticket from the authentication server employs a similar (with some differences) generation and processing process as those described for the INIT_PRINCIPAL_REP message. In this manner, the present invention discloses a unique on-line provisioning of user systems allowing user authentication.

While the above is a complete description of exemplary specific embodiments of the invention, additional embodiments are also possible. For example, it should be observed that a similar provisioning sequence can be used to register not only a consumer but other KDC 204 clients within the IPRM network. Examples of such clients are content provider 102, a caching server or other such clients within the scope and spirit of the present invention. Thus, the above description should not be taken as limiting the scope of the invention, which is defined by the appended claims along with their full scope of equivalents.

What is claimed is:

1. A provisioning system that secures delivery of a client public key, the provisioning system comprising:
a client to be registered;
a provisioning server for registering the client and assigning it a unique user ID (identification);
a key distribution center for generating a provisioning key associated with the user ID, the provisioning key being forwarded to the provisioning server;
the provisioning server generating configuration parameters for initializing the client, the provisioning key being included in the configuration parameters; and
upon initialization, the client provides its public key, authenticated with the provisioning key for forwarding to the key distribution center.

2. The provisioning system of claim 1 wherein the key distribution center stores the public key or generates a certificate.

3. The provisioning system of claim 1 further comprising
a provisioning ticket in which the provisioning key is also enclosed.

4. The provisioning system of claim 1 further comprising
a provisioning ticket for forwarding the provisioning key to the client.

5. The provisioning system of claim 4 further comprising
a ticket granting ticket obtained with an AS Request that is authenticated using a public key previously registered with the provisioning ticket, the ticket granting ticket used by the client for obtaining further tickets from the KDC, where each further ticket is used for obtaining access to a particular server.

6. The provisioning system of claim 1 wherein the client further provides to the provisioning system a host identifier that uniquely identifies a computer on which the client application is running.

7. A method for initially establishing trust between a KDC (Key Distribution Center) and a client having a uniquely identifiable user ID (identification) that was assigned by the provisioning server, the method comprising:
generating, by the KDC, a provisioning key associated with the user ID, the provisioning key being forwarded to the provisioning server;
forwarding the provisioning key to a provisioning server for registering the client;
generating, by the provisioning server, configuration parameters for initializing the client;
forwarding to the client, the provisioning key and the configuration parameters for initializing the client; and
upon initialization, the client provides its public key, authenticated with the provisioning key for forwarding to the key distribution center.

8. The method of claim 7 further comprising
a provisioning ticket for forwarding the provisioning key to the client.

9. The method of claim 8 further comprising
a ticket granting ticket obtained with an AS Request that is authenticated using a public key previously registered with the provisioning ticket, the ticket granting ticket used by the client for obtaining further tickets from the KDC, where each further ticket is used for obtaining access to a particular server.
